(19) United States
(12) Patent Application Publication
(10) Pub. No.: US 2009/0314441 A1
(43) Pub. Date: Dec. 24, 2009

(54) Decorative window covering

(76) Inventors: Bryan Ponder, Fenton, MO (US); Cindy Brewer, Fenton, MO (US)

Correspondence Address: THE MUELLER LAW OFFICE, P.C., 12951 Harwick Lane, San Diego, CA, 92130, US

(21) Appl. No.: 12/214,811

(22) Filed: Jun. 23, 2008

(51) Int. Cl. E06B 9/24; A47H 33/00

(52) U.S. Cl. 160/327

(57) ABSTRACT

A decorative window covering is disclosed which comprises a pleated sheet having a front side, a back side, a top end, and a bottom end, a stiffener member on the bottom end, and a pair of tabs which are adapted to be attached to the bottom end.

### BACKGROUND OF THE INVENTION

This invention relates to a decorative window covering and more particularly to a temporary window covering that has a decorative scene or motif for displaying the scene or motif during a holiday, a holiday season, or at any other time or season.

During a holiday or a holiday season it has become customary to display certain holiday or seasonal ornamentations inside or outside a building or a house to add to the holiday or season. For example, a flag having a shamrock for St. Patrick's Day or a flag having a pumpkin for Halloween are flown near and during the holiday. It is also known to display pennants or banners that include a holiday scene, emblem, logo, or image. Although such items are festive, special mounting devices are required to position or hold the flags, pennants, or banners in place during use. Such devices need to be installed or permanently affixed to a wall, door, ceiling, or post. As can be appreciated, it would be desirable to display a holiday decoration without having to install a device to hold the decoration.

It is also known to have a temporary covering for a window constructed from a pleated material. However, such coverings have a tendency to bow or become distorted at a bottom end. Such bowing or distortion is unsightly and aesthetically unattractive. Even when a stiffening member is applied to the bottom end such window covering still bows and does not present a horizontal appearance. It would be advantageous to display a holiday decoration that is attractive and does not bow or become distorted when in use.

The present invention is designed to obviate and overcome many of the disadvantages and shortcomings associated with prior decorations. In particular, the present invention is a decorative window covering that can be used to temporarily display a holiday scene or decoration. Further, the decorative window covering of the present invention may be used to prevent bowing of the decorative window covering when in use.

### SUMMARY OF THE INVENTION

In one form of the present invention, a decorative window covering comprises a pleated sheet having a front side, a back side, a top end, and a bottom end, a stiffener member on the bottom end, and a pair of tabs which are adapted to be attached to the bottom end.

In another form of the present invention, a decorative window covering comprises a pleated sheet having a front side, a back side, a top end, and a bottom end, a decorative scene on the front side, a stiffener member on the bottom end, and a pair of tabs which are adapted to be attached to the bottom end.

In still another form of the present invention, a decorative window covering comprises a sheet having a front side, a back side, a top end, and a bottom end, a stiffener member on the bottom end, and a pair of tabs which are adapted to be attached to the bottom end.

In light of the foregoing comments, it will be recognized that a principal object of the present invention is to provide a decorative window covering that is of simple construction and design and which can be easily employed with highly reliable results.

Another object of the present invention is to provide a decorative window covering that may be temporarily attached or mounted to a window opening or window frame.

Another object of the present invention is to provide a decorative window covering that does not bow or distort when in use.

A still further object of the present invention is to provide a decorative window covering that is easy to install and remove after use.

Another object of the present invention is to provide a decorative window covering that is inexpensive to manufacture, ship, and may be contained or stored in a compressed, rolled, or compact form.

A still further object of the present invention is to provide a decorative window covering that is reusable from season to season.

Another object of the present invention is to provide a decorative window covering that may be temporarily attached or mounted to a wall or an existing window blind or shade.

These and other objects and advantages of the present invention will become apparent after considering the following detailed specification in conjunction with the accompanying drawings, wherein:

### BRIEF DESCRIPTION OF THE DRAWINGS

FIG. 1 is a front perspective view of a preferred embodiment of a decorative window covering constructed according to the presenting invention in a fully extended position attached to a window frame constructed;

FIG. 2 is a perspective view of the decorative window covering shown in FIG. 1 in a stored state;

FIG. 3 is a partial bottom view of the decorative window covering constructed according to the present invention;

FIG. 4 is a side perspective view of a tab;

FIG. 5 is a front perspective view of another preferred embodiment of a decorative window covering constructed according to the present invention;

FIG. 6 is a front perspective view of another preferred embodiment of a decorative window covering constructed according to the present invention; and

FIG. 7 is a front perspective view of the decorative window covering shown in FIG. 6 in a partially extended position.

### DETAILED DESCRIPTION OF THE PREFERRED EMBODIMENTS

Referring now to the drawings, wherein like numbers refer to like items, number 10 identifies a preferred embodiment of a decorative window covering constructed according to the present invention. With reference now to FIGS. 1, 2, and 4, the decorative window covering 10 comprises a sheet 12 having a front side 14, a back side 16, a top end 18, a bottom end 20, a stiffener member 22 on the bottom end 20, and a pair of tabs 24 and 26 which are adapted to be attached to the bottom end 20 or the stiffener member 22. The top end 18 has a releasable strip 28 which is used to cover a strip of adhesive 30. The top end 18 may also have a stiffener member. The stiffener member may be formed of cardboard, chipboard, or any other weighted card stock.

The sheet 12 may consist of a translucent material, an opaque material such as paper such as Kraft paper, plastic, cloth or fabric. Further, the material may have a protective coating to prolong use or to protect against ultraviolet (UV) light or radiation. The sheet 12 is also capable of being cut to size in order to fit in different sized windows. The sheet 12 may also be tear resistant to reduce damaging the covering 10 when in use, during removal, or when in storage.

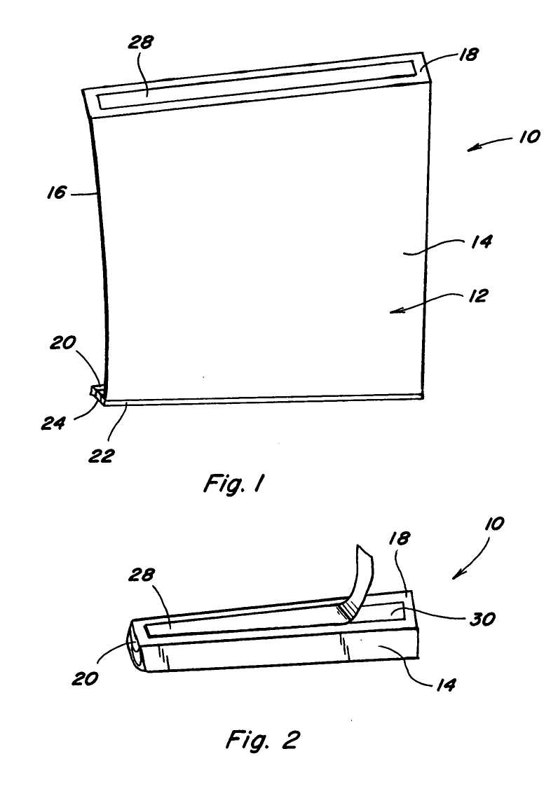

With particular reference now to FIG. 2, the decorative window covering 10 is shown in a stored state. For example, the covering 10 may be rolled for storage or transportation in a container (not shown). The releasable strip 28 has been partially released to reveal the strip of adhesive 30. Although not shown, it is possible that the strip of adhesive 30 can be pair of side by side strips of adhesive and when one of the strips becomes worn through use the other strip may be used. When the covering 10 is to be used, the covering is rolled out, the releasable strip 28 is removed, and the strip of adhesive 30 is used to attach the covering 10 to a window opening.

Although not shown in the particular embodiment depicted in FIGS. 1 and 2, it is possible and contemplated to have a design imprinted on the front side 14 to be presented to a viewer. The design may be of any color, motif, logo, or holiday scene.

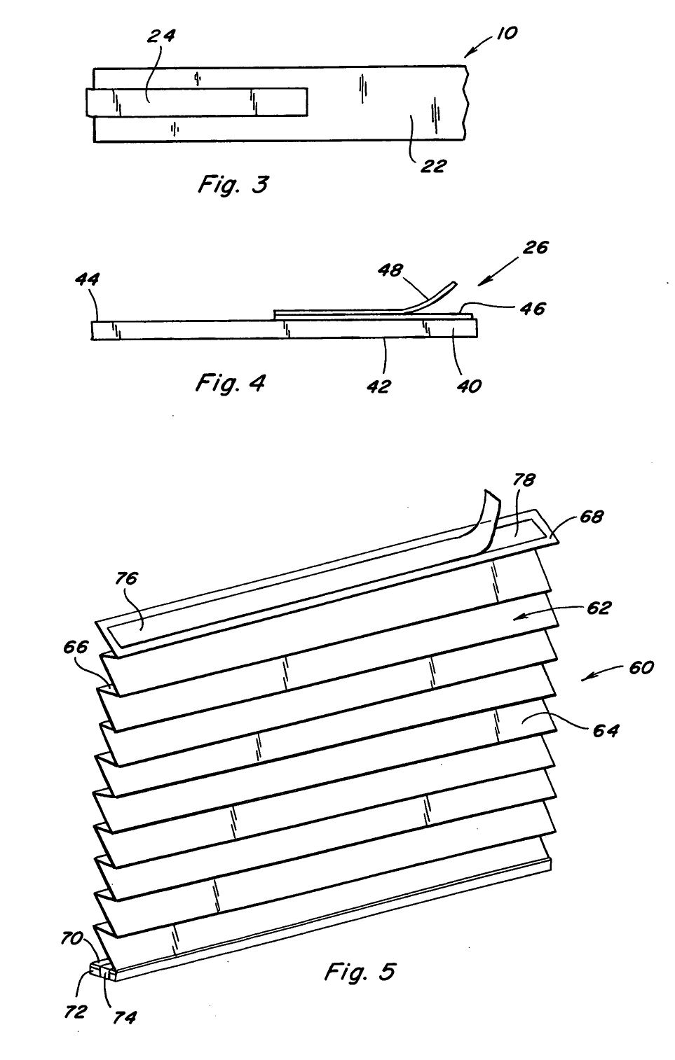

FIG. 3 illustrates a partial bottom perspective view of the decorative window covering 10 with the tab 24 attached to the stiffener member 22. The tab 24 is adapted to span a portion of the length of the bottom end 20 in order to prevent the bottom end 20 from bowing or bending. In this manner, the tab 24 helps to keep the bottom end 20 in a horizontal position or orientation.

With reference now to FIG. 4, a side perspective view of the tab 26 is shown. The tab 26 comprises a main body portion 40 having a bottom side 42, a top side 44, a layer of adhesive 46 applied to the top side 44, and a releasable strip 48 for covering the layer of adhesive 46. The layer of adhesive 46 is used to attach the tab 26 to the stiffener member 22 and the bottom end 20. The layer of adhesive 46 is shown spanning a portion of the length of the tab 26, such as half the length of the tab 26. In this manner the tab 26 can easily be bent, moved, or positioned when disassembling the covering 10. However, it is also possible that the layer of adhesive 46 can span the entire length of the tab 26. The tab 26 has a length that is adapted to span a portion of the length of the bottom end 20 and the stiffener member 22 in order to prevent the bottom end 20 from bowing. The tabs 24 and 26 can have a length of five inches. The tabs 24 and 26 can be a twist tie type device in which a wire is placed within the main body portion 40 to provide added strength to the tabs 24 and 26. The tabs 24 and 26 may have markings on the main body portion 40 to assist in centering or positioning the tabs 24 and 26 on the bottom end 20 and the stiffener member 22.

FIG. 5 illustrates another preferred embodiment of a decorative window covering 60. The decorative window covering 60 comprises a pleated sheet 62 having a front side 64, a back side 66, a top end 68, a bottom end 70, a stiffener member 72 on the bottom end 70, and a pair of tabs 74, only one of which is shown, which are adapted to be attached to the bottom end 70 or the stiffener member 72. The top end 68 has a releasable strip 76 which is used to cover a strip of adhesive 78. The top end 68 may also have a stiffener member. The pleated sheet 62 may consist of a translucent material, an opaque material such as paper such as Kraft paper, plastic, cloth, or fabric. Further, the material may have a protective coating to prolong use or to protect against ultraviolet (UV) light or radiation. The pleated sheet 62 is also capable of being cut to size in order to fit in different sized windows. The pleated sheet 62 may also be tear resistant to reduce damaging the covering 60 when in use, removal, or storage. The tabs 74 are the same as the tabs 24 and 26.

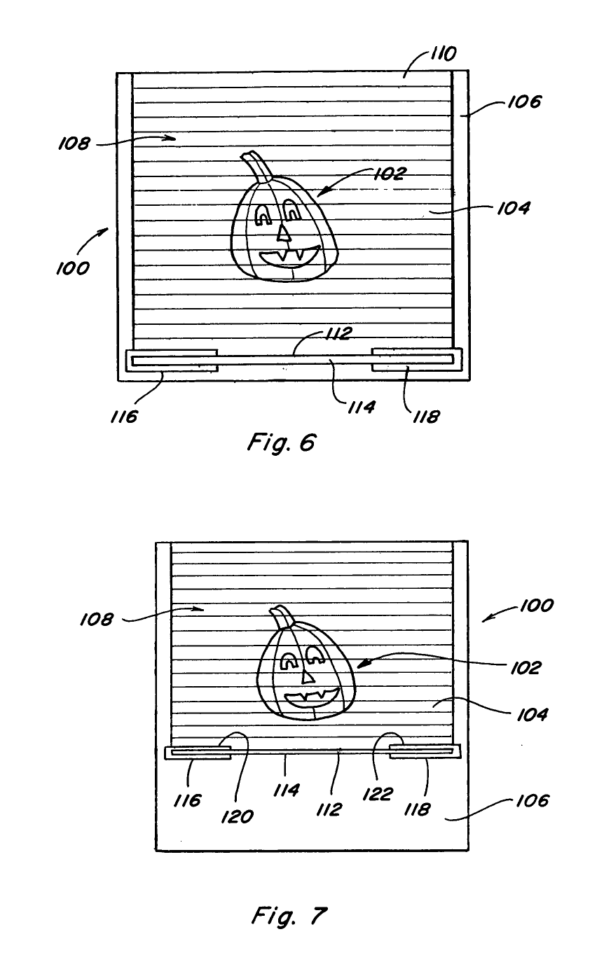

Referring now to FIG. 6 a front perspective view of another preferred embodiment of a decorative window covering 100 is depicted. The decorative window covering 100 is similar to the covering 60 except that a decorative element 102 has been printed on a front side 104 of the covering 100. In this particular drawing the decorative element 102 is a jack-o'-lantern. The covering 100 is shown installed in a window opening 106. The decorative window covering 100 comprises a pleated sheet 108 having the front side 104, a back side (not shown), a top end 110, a bottom end 112, a stiffener member 114 on the bottom end 112, and a pair of tabs 116 and 118 which are adapted to be attached to the bottom end 112 and the stiffener member 114. The tabs 116 and 118 are the same as the tabs 24 and 26. Also, the tabs 116 and 118 extend along a portion of the length of the bottom end 112 in order to prevent the bottom end 112 from bowing or bending. Although not shown, the top end 110 may have an adhesive strip for securing the top end 110 to the window opening 106.

FIG. 7 illustrates the decorative window covering 100 in a partially extended position. The covering 100 may be extended at any desired position within the window opening 106 by using the tabs 116 and 118 to hold any number of pleats in the pleated sheet 108. As has been previously discussed with respect to the tabs 24 and 26, the tabs 116 and 118 may have adhesive on a portion of the tabs 116 and 118. Each of the tabs 116 and 118 each has a portion 120 and 122, respectively, that do not have adhesive. These portions 120 and 122 may be easily bent or moved when adjusting the length of the covering 100. Further, the tabs 116 and 118 also prevent the bottom end 112 or the stiffener member 114 from bending, bowing, or sagging when in a partially extended position.

The pleated sheet 108 may consist of a transparent material, an opaque material such as paper such as Kraft paper, plastic, cloth or fabric. Further, the material may have a protective coating to prolong use or to protect against ultraviolet (UV) light or radiation. The pleated sheet 108 is also capable of being cut to size in order to fit in different sized windows. The pleated sheet 108 may also be tear resistant to reduce damaging the covering 100 when in use, removal, or storage.

As can be appreciated, various other designs, motifs, logos, colors, textures, patterns, or holiday scenes may be printed, imprinted, painted, or silk screened on the decorative window coverings 10, 60, and 100.

From all that has been said, it will be clear that there has thus been shown and described herein a decorative window covering which fulfills the various objects and advantages sought therefor. It will become apparent to those skilled in the art, however, that many changes, modifications, variations, and other uses and applications of the subject decorative window covering are possible and contemplated. All changes, modifications, variations, and other uses and applications which do not depart from the spirit and scope of the invention are deemed to be covered by the invention, which is limited only by the claims which follow.

What is claimed is:

1. A decorative window covering comprising a pleated sheet having a front side, a back side, a top end, and a bottom end, a stiffener member on the bottom end, and a pair of tabs which are adapted to be attached to the bottom end.

2. The decorative window covering of claim 1 wherein the pair of tabs are adhesively attached to the bottom end.

3. The decorative window covering of claim 1 wherein the pair of tabs each have a length that prevents the bottom end from bowing.

4. The decorative window covering of claim 1 further comprising an adhesive on the top end.

5. The decorative window covering of claim 1 further comprising a stiffener member on the top end.

6. The decorative window covering of claim 1 wherein the bottom end has a length and the pair of tabs each has a length with the lengths of the tabs adapted to span a portion of the length of the bottom end to prevent the bottom end from bowing.

7. The decorative window covering of claim 6 wherein each of the tabs has an adhesive for attaching to the bottom end.

8. The decorative window covering of claim 1 wherein each of the tabs is a twist tie having a main body portion having a wire inserted in the main body portion, a top side, and a layer of adhesive on the top side.

9. The decorative window covering of claim 1 wherein the pleated sheet is adapted to being compressed to store the decorative window covering.

10. A decorative window covering comprising a pleated sheet having a front side, a back side, a top end, and a bottom end, a decorative element on the front side, a stiffener member on the bottom end, and a pair of tabs which are adapted to be attached to the bottom end.

11. The decorative window covering of claim 10 wherein the pair of tabs are adhesively attached to the bottom end.

12. The decorative window covering of claim 10 wherein the pair of tabs each have a length that prevents the bottom end from bowing.

13. The decorative window covering of claim 10 further comprising an adhesive on the top end.

14. The decorative window covering of claim 10 further comprising a stiffener member on the top end.

15. The decorative window covering of claim 10 wherein the bottom end has a length and the pair of tabs each has a length with the lengths of the tabs adapted to span a portion of the length of the bottom end to prevent the bottom end from bowing.

16. The decorative window covering of claim 10 wherein each of the tabs is a twist tie having a main body portion having a wire inserted in the main body portion, a top side, and a layer of adhesive on the top side.

17. A decorative window covering comprising a sheet having a front side, a back side, a top end, and a bottom end, a stiffener member on the bottom end, and a pair of tabs which are adapted to be attached to the bottom end.

18. The decorative window covering of claim 17 wherein each of the tabs is a twist tie having a main body portion having a wire inserted in the main body portion, a top side, and a layer of adhesive on the top side.

19. The decorative window covering of claim 17 further comprising a decorative element on the front side.

20. The decorative window covering of claim 17 wherein the sheet is adapted to being rolled up to store the decorative window covering.
